(19) United States
(12) Patent Application Publication
(10) Pub. No.: US 2019/0173304 A1
(43) Pub. Date: Jun. 6, 2019

(54) BATTERY CHARGING APPARATUS

(71) Applicant: NTN CORPORATION, Osaka-shi, Osaka (JP)

(72) Inventor: Masaji HANEDA, Shiga (JP)

(73) Assignee: NTN CORPORATION, Osaka-shi (JP)

(21) Appl. No.: 16/306,650

(22) PCT Filed: May 9, 2017
(86) PCT No.: PCT/JP2017/017469

§ 371 Date: Dec. 3, 2018

(30) Foreign Application Priority Data
Jun. 2, 2016 (JP) 2016-111247

(51) Int. Cl. H02J 7/00; H02M 7/12; H02M 1/42; H02J 7/04; H01M 10/44

(52) U.S. Cl. CPC H02J 7/0052; H02M 7/12; H01M 10/44; H02J 7/045; H02M 1/4208

(57) ABSTRACT

A battery charging apparatus is provided which, without conducting smoothing after an alternating current is rectified, improves the power factor and charges a battery using an output containing a ripple, the battery charging apparatus being capable of generating the output containing a ripple by utilizing a simple configuration and easy control.

### TECHNICAL FIELD

The present invention relates to a battery charging apparatus which charges a rechargeable battery such as a lead storage battery and a secondary battery.

### BACKGROUND ART

Conventionally, an AC/DC converter is known as the charging apparatus for a rechargeable battery (below called simply the “battery”) such as a lead storage battery and a secondary battery. The AC/DC converter rectifies a single-phase or three-phase alternating current, allows a switching converter to conduct an electric-power conversion thereof and outputs it to the battery. In this case, after the alternating current is rectified, the waveform becomes a periodic rectification waveform formed by the half period of the sinusoidal wave or a part thereof. The period of the rectification waveform causes a variation in the voltage or electric current at the following stage, and the variation component is called a “ripple”. The frequency of the ripple is basically an integral multiple of the alternating current before rectified, and in some cases, non-periodical noise may be added thereto. Over a period of many years, there has been general recognition that in the output of the battery charging apparatus, the ripple will deteriorate the charging efficiency. Hence, a large number of arts have been proposed for the purpose of eliminating the ripple (Patent Document 1 and the like).

On the other hand, Patent Documents 2 and 3 propose charging a battery by, without conducting smoothing after an alternating current is rectified, directly utilizing a periodic pulsating current caused by the rectification waveform. This proposal is made by paying close attention to the facts that no problem is raised even if a battery is charged with a pulsating current and that an internal resistance of the battery can be easily measured by utilizing a high ripple voltage generated between the terminals of the battery by the pulsating current. In Patent Documents 2 and 3, the start and stop of charging are controlled by measuring a battery internal resistance and thereby detecting a charge state.

Patent Documents 2 and 3 disclose three configurations: utilizing, as the charge output, a pulsating current almost directly after an alternating current is rectified; utilizing, as the charge output, an output generated by a voltage converter which converts the voltage of a pulsating current after an alternating current is rectified; and utilizing, as the charge output, an output generated by a switching converter corresponding to a power-factor improving means for improving the power factor of a pulsating current after an alternating current is rectified. In Patent Document 3, an insulating switching converter having a flyback system is employed as an example of the power-factor improving means.

### PRIOR ART DOCUMENTS

### Patent Documents

Patent Document 1: Japanese Patent Laid-Open Publication No. 2003-17136

Patent Document 2: Japanese Patent Laid-Open Publication No. 2016-39742

Patent Document 3: Japanese Patent Laid-Open Publication No. 2016-63622

Patent Document 4: Japanese Patent Laid-Open Publication No. 2005-218224

Patent Document 5: Japanese Patent Laid-Open Publication No. 2007-37297

### SUMMARY OF THE INVENTION

### Problems to be Solved by the Invention

However, Patent Documents 2 and 3 do not disclose a controlling section in detail which controls the switching of the switching converter corresponding to the power-factor improving means. In general, the power-factor improving means formed by a switching converter executes extremely complicated control in PWM control for driving a switching element thereof. For example, Patent Documents 4 and 5 disclose a power-factor improvement circuit which generates a complicated PWM control signal for detecting an input voltage and an output voltage and changing the ON time and OFF time of a pulse constantly according to the input and output voltages. Hence, the conventional power-factor improving means requires the large and expensive controlling section.

If a battery is charged with a ripple charge output containing a large ripple, then an internal resistance of the battery can be easily measured. However, the controlling section of a switching converter for improving the power factor becomes larger and more expensive.

In view of the above problems, it is an object of the present invention to provide a battery charging apparatus which, without conducting smoothing after an alternating current is rectified, allows a switching converter thereof to improve the power factor and outputs a ripple charge output containing a large ripple to a battery, the battery charging apparatus being capable of generating the ripple charge output by utilizing a simple configuration and easy control.

### Means for Solving the Problems

In order to accomplish the object, a battery charging apparatus according to the present invention has the following configuration. The reference numerals and characters in parentheses are equivalent to those denoted in the figures described later and are given for reference.

A battery charging apparatus according to an aspect of the present invention includes a rectifying section (2) rectifying an alternating current inputted into the rectifying section (2) and a power-factor improving section (3) arranged at the stage following the rectifying section (2), and generates a ripple charge output containing a ripple which is caused by a rectification voltage waveform formed by the rectifying section (2), wherein: the power-factor improving section (3) is formed by a switching converter including a switching element (Q) and a PWM controlling IC (4), the PWM controlling IC (4) outputting a PWM control signal (Vp) to a control end of the switching element (Q) during a period when a battery (6) is charged; and the PWM control signal (Vp) is a pulse signal having a constant duty factor.

The battery charging apparatus according to the above aspect comprises a charge-voltage detecting section (5) detecting a battery charge voltage (Vbat) of the battery (6), wherein the charge-voltage detecting section (5) outputs a signal for stopping the PWM controlling IC (4) from outputting the PWM control signal (Vp) if the battery charge voltage (Vbat) rises above a first voltage, and outputs a signal for allowing the PWM controlling IC (4) to start outputting the PWM control signal (Vp) if the battery charge voltage (Vbat) falls below a second voltage lower than the first voltage.

In the battery charging apparatus according to the above aspect, the power-factor improving section (3) is formed as an insulating switching converter having a flyback system or a forward system.

### Advantages of the Invention

The battery charging apparatus according to the present invention, without conducting smoothing after an alternating current is rectified, allows a switching converter thereof to improve the power factor and outputs a ripple charge output containing a large ripple to a battery. In the battery charging apparatus, the PWM control signal for controlling the switching element of the power-factor improving section is a pulse signal having a constant duty factor over the period when the battery is charged. Therefore, the battery charging apparatus is capable of generating the ripple charge output by utilizing a simple configuration and easy control.

### BRIEF DESCRIPTION OF THE DRAWINGS

FIG. 1 is a schematic block diagram showing an example of the configuration of a battery charging apparatus according to an embodiment of the present invention.

FIGS. 2(a) to 2(h) are individually a graphical representation typically showing a variation over time in the electric current or voltage at each point of the configuration of FIG. 1.

FIGS. 3(a) to 3(c) are individually a graphical representation typically showing a variation over time in the battery charge voltage of a battery and in the outputs of a charge-voltage detecting section and a PWM controlling IC respectively, in the configuration of FIG. 1.

### MODE FOR CARRYING OUT THE INVENTION

Embodiments of a battery charging apparatus according to the present invention will be below described with reference to the drawings.

Configuration of the Battery Charging Apparatus

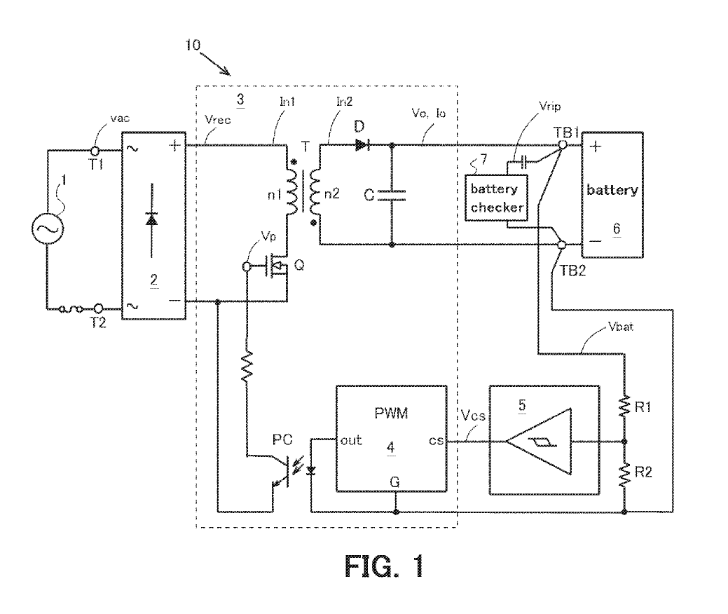

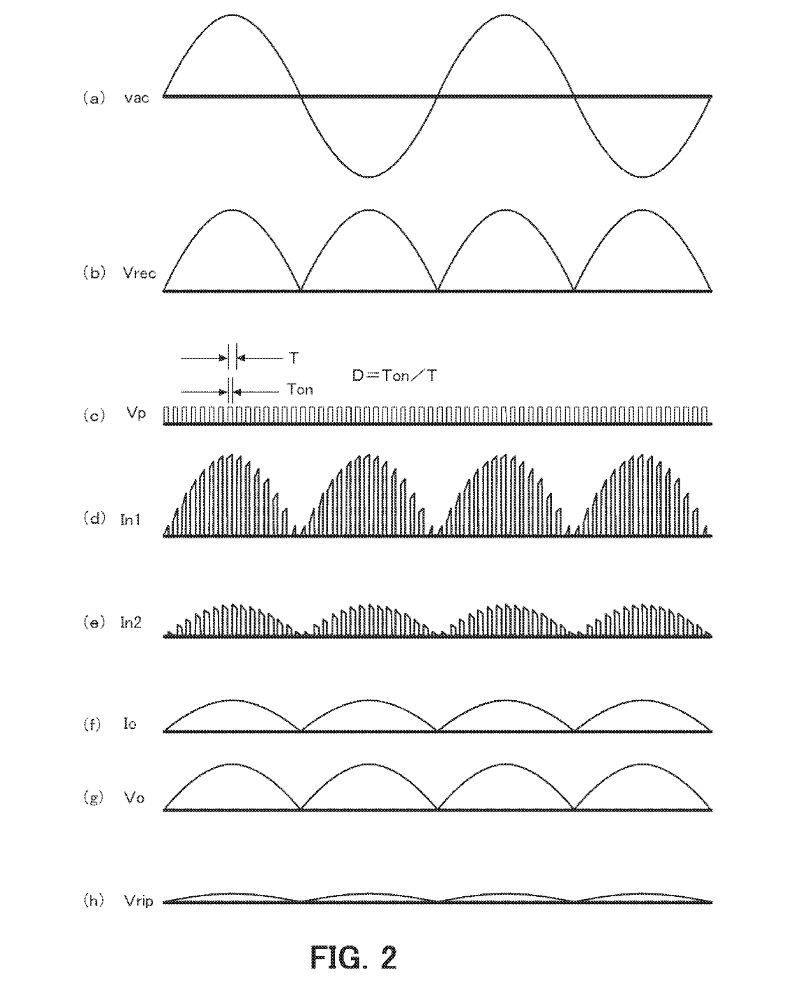

FIG. 1 is a schematic block diagram showing an example of the configuration of a battery charging apparatus according to an embodiment of the present invention. FIGS. 2(a) to 2(h) are individually a graphical representation typically showing a variation over time in the electric current or voltage at each point of the configuration of FIG. 1.

A battery charging apparatus 10 according to the present invention includes a rectifying section 2, a power-factor improving section 3 including a PWM controlling IC 4, and a charge-voltage detecting section 5. Into the rectifying section 2, an alternating current is inputted from an AC power source 1. The power-factor improving section 3 supplies a ripple charge output to a battery 6.

The “ripple charge output” is an output for a battery charge, meaning voltage and electric-current outputs which each involve a variation caused by a rectification voltage waveform generated by the rectifying section 2. The variation typically has the same period as that of the rectification voltage waveform. The electric current of the ripple charge output is called the “ripple output current” and the voltage thereof is called the “ripple output voltage”. FIG. 2(f) shows an example of the ripple output current lo and FIG. 2(g) shows an example of the ripple output voltage Vo.

As an example, the AC power source 1 is a single-phase-AC commercial power source which has a voltage of 100V or 200V and a frequency of 50 Hz or 60 Hz. FIG. 2(a) shows an AC voltage vac of the AC power source 1. The AC voltage vac has the waveform of a sinusoidal wave and is inputted into input ends T1 and T2 of the battery charging apparatus 10. The alternating current is inputted into the input ends T1 and T2, and then, into an AC input terminal of the rectifying section 2. The rectifying section 2 is, for example, a bridge rectification circuit, but is not limited to this. It may preferably be a full-wave rectification circuit, but may also be a half-wave rectification circuit. FIG. 2(b) shows a rectification voltage Vrec obtained after the rectifying section 2 subjects the alternating current to full-wave rectification. The rectification voltage Vrec is outputted between the positive output end and the negative output end of the rectifying section 2. Preferably, a noise elimination circuit (not shown) may be provided at the stage preceding the rectifying section 2.

As shown in FIG. 2(b), the rectification voltage Vrec has a waveform shaped by continuing the half-period waveform of the AC sinusoidal wave on the positive-electrode side. If the single-phase alternating current is subjected to full-wave rectification, then the frequency of the rectification voltage Vrec becomes twice as high as the frequency of the AC power source 1.

The rectification voltage Vrec is outputted to the positive output end and the negative output end of the rectifying section 2, and then, is inputted to the power-factor improving section 3 at the following stage. In this example, the power-factor improving section 3 is formed as an insulating flyback converter. The power-factor improving section 3 is not limited to this, and hence, may be an insulating forward converter. Or alternatively, it may be a non-insulating step-up chopper or step-down chopper. A switching converter having any formation can be employed, as long as the switching converter has the power-factor improving function of outputting an electric current of the same sinusoidal wave and the same phase as the input voltage. As a common formation thereto, a switching element Q is provided for the purpose of switch control.

An end of a primary coil n1 of a transformer T is connected to the positive output end of the rectifying section 2, and the other end thereof is connected to an end (drain) of the switching element Q (an n-channel FET in the example). The other end (source) of the switching element Q is connected to the negative output end of the rectifying section 2. On the other hand, an end of a secondary coil n2 of the transformer T is connected to a negative terminal TB2 of the battery 6, and the other end thereof is connected to the anode of an output diode D. The cathode of the output diode D is connected to a positive terminal TB1 of the battery 6. A capacitor C is connected between the cathode of the output diode D and an end of the transformer T. FIG. 1 shows only a fundamental configuration, and thus, a snubber circuit or the like is omitted which is generally provided in an insulating flyback converter.

FIGS. 2(d) and 2(e) show, in the transformer T of FIG. 1, an example of the waveform of each of an electric current In1 of the primary coil n1 and an electric current In2 of the secondary coil n2 respectively. These waveforms will be described in detail in the operation described later.

The power-factor improving section 3 also has the voltage conversion function of converting the rectification voltage Vrec into a suitable voltage for charged equipment. The voltage conversion can be realized by setting a turn ratio of the coil of the transformer T.

The switching element Q includes a control end driven using a PWM control signal Vp. The switching element Q is not limited to an n-channel FET, and hence, may be a p-channel FET, an IGBT or a bipolar transistor.

FIG. 2(c) shows the PWM control signal Vp, and the PWM controlling IC 4 generates the PWM control signal Vp. The PWM controlling IC 4 is well known, and various types thereof are on the market. In general, the PWM controlling IC 4 includes as a common formation thereof: a control terminal cs for inputting a control voltage Vcs into the PWM controlling IC 4; and an output terminal out for outputting the PWM control signal Vp having a predetermined duty factor. The PWM controlling IC 4 is designed to output, from the output terminal out, the PWM control signal Vp having a duty factor proportional to the control voltage Vcs inputted through the control terminal cs.

In the configuration of FIG. 1, the switching converter is of the insulation type, thereby requiring insulating the feedback path from the output side as well. The PWM control signal Vp is sent via photo-coupler PC to the switching element Q.

In the battery charging apparatus 10 according to the present invention, the charge-voltage detecting section 5 outputs the control voltage Vcs. The control voltage Vcs is any of two values of voltage (called H and L). Into the charge-voltage detecting section 5, a voltage proportional to a voltage between the positive terminal TB1 and the negative terminal TB2 of the battery 6 is inputted, and thereby, the charge-voltage detecting section 5 detects a charge state of the battery 6. The charge-voltage detecting section 5 outputs the control voltage Vcs of H during a period when the battery charging apparatus 10 is charging the battery 6. On the other hand, it outputs the control voltage Vcs of L during a period when the battery 6 is discharging or is not being charged.

If the charge-voltage detecting section 5 outputs H as the control voltage Vcs, then as shown in FIG. 2(c), the PWM controlling IC 4 outputs the PWM control signal Vp equivalent to a pulse signal. A duty factor D of the PWM control signal Vp is the ratio of an ON period Ton to a period T of the pulse signal, or D=Ton/T. In the battery charging apparatus 10 according to the present invention, the control voltage Vcs is kept constant over the charge period. Hence, the duty factor D of the PWM control signal Vp is constant and remains unchanged.

The internal formation of the PWM controlling IC 4 is not shown, but a rough formation thereof is as follows. In order to obtain a practically-necessary duty factor, the control voltage Vcs is multiplied by an appropriate proportionality factor to obtain a predetermined voltage. Then, the predetermined voltage and a high-frequency carrier triangular-wave voltage are inputted into a comparator, and the comparator generates, as an output signal thereof, the PWM control signal Vp equivalent to the pulse signal having the constant duty factor D.

The PWM control signal Vp of FIG. 2(c) is shown, as can be easily seen, by enlarging the pulse width. The switching frequency of the switching converter is several kHz to several hundred Hz, and in practice, it is even higher than the AC power-source frequency shown in FIG. 2(a).

On the other hand, if the charge-voltage detecting section 5 outputs L as the control voltage Vcs, then the PWM controlling IC 4 will not output the PWM control signal Vp. At this time, the battery charging apparatus 10 is stopped.

The battery 6 is, as an example, a 12-volt seal-type lead storage battery which is formed by connecting six 2-volt lead storage cells in series. The battery 6 may be provided with a battery checker 7 detecting the battery 6 deteriorating. The battery checker 7 detects a variation in the voltage between the positive terminal TB1 and the negative terminal TB2 of the battery 6. In other words, it detects a battery-terminal ripple voltage Vrip as an AC component. FIG. 2(h) shows the battery-terminal ripple voltage Vrip, and the amplitude thereof is proportional to the battery internal resistance. Hence, the internal resistance becomes greater as the battery 6 deteriorates.

### (2) Operation of the Battery Charging Apparatus

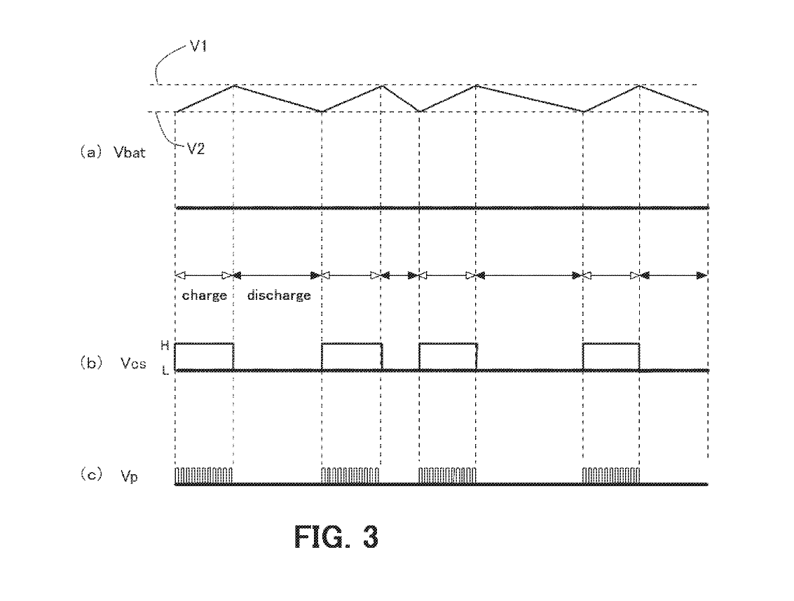

FIGS. 3(a) to 3(c) are individually a graphical representation typically showing a variation over time in the battery charge voltage of the battery 6 and in the outputs of the charge-voltage detecting section 5 and the PWM controlling IC 4 respectively, in the configuration of FIG. 1. The battery charging apparatus 10 according to the present invention will be described with reference to FIG. 1 and FIG. 2 as well.

In the battery charging apparatus 10, only if the AC voltage vac from the AC power source 1 is inputted into the rectifying section 2, and the PWM control signal Vp is transmitted to the power-factor improving section 3, then the ripple charge outputs Vo and lo are outputted.

The PWM controlling IC 4 generates and stops the PWM control signal Vp, and the generation and stop are controlled by the charge-voltage detecting section 5. The charge-voltage detecting section 5 detects a battery charge voltage Vbat, and on the basis of the detection, controls the PWM controlling IC 4.

FIG. 3(a) illustrates, when a charge and a discharge are repeated, a variation over time in the battery charge voltage Vbat of the battery 6. The discharge is given, for example, by connecting a suitable load to the battery 6. In the case of the 12-volt lead storage battery, for example, a full-charge voltage V1 is 14 volts and a discharge cut-off voltage V2 is 12.6 volts. In the example of the figure, all the charge periods are the same, but the discharge periods are different from each other in accordance with a load condition or the like.

FIG. 3(b) illustrates a variation over time in the control voltage Vcs asthe output of the charge-voltage detecting section 5. The figure corresponds to FIG. 3(a). The charge-voltage detecting section 5 is designed to be a comparating amplifier which generates a two-valued output having a hysteresis. The control voltage Vcs is H during a period when the battery 6 is being charged. The control voltage Vcs is kept at H until the battery charge voltage Vbat rises gradually and reaches the full-charge voltage V1. If the battery charge voltage Vbat rises above the full-charge voltage V1, the control voltage Vcs becomes L. As a result, the charge of the battery 6 comes to a stop. Subsequently, while the battery 6 is being discharged, the battery charge voltage Vbat falls gradually, but the control voltage Vcs is kept at L until the battery charge voltage Vbat reaches the discharge cut-off voltage V2. If the battery charge voltage Vbat falls below the discharge cut-off voltage V2, the control voltage Vcs becomes H. As a result, the battery 6 starts to be charged.

FIG. 3(c) illustrates a variation over time in the PWM control signal Vp as the output of the PWM controlling IC 4. The figure corresponds to FIGS. 3(a) and 3(b). During a period when the battery 6 is being charged, or during a period when the control voltage Vcs of the charge-voltage detecting section 5 is H, the PWM control signal Vp having the constant duty factor D continues to be outputted. On the other hand, during a period when the battery 6 is being discharged, or during a period when the control voltage Vcs of the charge-voltage detecting section 5 is L, the PWM control signal Vp is not outputted.

During a charge period, the power-factor improving section 3 is in operation. If the pulse signal of the PWM control signal Vp is turned ON to electrically conduct the switching element Q, then the rectification voltage Vrec is applied to the primary coil n1. The electric current Int flowing through the primary coil n1 increases gradually during the ON period by a slope which is determined by the instantaneous value of the rectification voltage Vrec at the ON point of time and the inductance of the primary coil n1. On the other hand, the output diode D becomes an inverse bias to the electromotive force generated by the secondary coil n2, thereby hindering an electric current from flowing through the secondary coil n2. As a result, the magnetic energy is stored in the transformer T.

If the pulse signal of the PWM control signal Vp is turned OFF to interrupt the switching element Q, then the electric current In1 of the primary coil n1 becomes zero. On the other hand, the output diode D becomes a forward bias to the counter-electromotive force generated by the secondary coil n2. Hence, the electric current In2 flows through the secondary coil n2, and the magnetic energy is emitted. During the OFF period, the electric current In2 decreases gradually from the peak value at the OFF point of time when the magnetic energy is at the maximum.

FIGS. 2(d) and 2(e) show an example of the waveform of each of the electric current In1 and the electric current In2 respectively. The waveform formed by linking the peak value (or average value) of the electric current In2 flowing through the secondary coil n2 to one period of the PWM control signal Vp is a sinusoidal wave which has the same polarity and the same period as those of the rectification voltage Vrec. This indicates a power factor of 1. FIGS. 2(d) and 2(e) individually show the electric current in a continuous mode, but the present invention also includes the case of a critical mode or a discontinuous mode.

FIGS. 2(f) and 2(g) show the ripple output current Io and the ripple output voltage Vo. This ripple output is supplied between the positive terminal TB1 and the negative terminal TB2 of the battery 6, and the battery 6 is charged. As an example, the average value of the ripple output voltage Vo is substantially equal to the full-charge voltage V1.

### (3) Other Embodiments

As describe above, the battery charging apparatus according to the present invention has been described using the example in which a lead storage battery is charged. However, the battery charging apparatus according to the present invention is not limited to a lead storage battery. The battery charging apparatus according to the present invention can also be applied to a lithium-ion battery, a nickel-cadmium rechargeable battery and a nickel-hydrogen rechargeable battery.

### DESCRIPTION OF THE SYMBOLS

1 AC power source
2 rectifying section
3 power-factor improving section
4 PWM controlling IC
5 charge-voltage detecting section
6 battery
7 battery checker

1-3. (canceled)

4. A battery charging apparatus which includes a rectifying section (2) rectifying an alternating current inputted into the rectifying section (2) and a power-factor improving section (3) arranged at the stage following the rectifying section (2), and generates a ripple charge output containing a ripple which is caused by a rectification voltage waveform formed by the rectifying section (2);
wherein the power-factor improving section (3) is formed by a switching converter including a switching element (Q) and a PWM controlling IC (4), the PWM controlling IC (4) outputting a PWM control signal (Vp) to a control end of the switching element (Q) during a period when a battery (6) is charged; and
wherein the PWM control signal (Vp) is a pulse signal having a constant duty factor.

5. The battery charging apparatus according to claim 4, wherein the power-factor improving section (3) is formed as an insulating switching converter having a flyback system or a forward system.

6. The battery charging apparatus according to claim 4, further comprising a charge-voltage detecting section (5) detecting a battery charge voltage (Vbat) of the battery (6);
wherein the charge-voltage detecting section (5) outputs a signal for stopping the PWM controlling IC (4) from outputting the PWM control signal (Vp) if the battery charge voltage (Vbat) rises above a first voltage, and outputs a signal for allowing the PWM controlling IC (4) to start outputting the PWM control signal (Vp) if the battery charge voltage (Vbat) falls below a second voltage lower than the first voltage.

7. The battery charging apparatus according to claim 6, wherein the power-factor improving section (3) is formed as an insulating switching converter having a flyback system or a forward system.
